(19) United States
(12) Patent Application Publication
(10) Pub. No.: US 2001/0056351 A1
(43) Pub. Date: Dec. 27, 2001

(54) Networked audio posting method and system

(75) Inventors: Jeffrey M. Valentine, Cambridge, MA (US); Michael Bernardo, Andover, MA (US); Benjamin Krysiak, Charlestown, MA (US)

Correspondence Address: FOLEY, HOAG & ELIOT, LLP, PATENT GROUP, ONE POST OFFICE SQUARE, BOSTON, MA, 02109, US

(73) Assignee: BYOBroadcast, Inc.

(21) Appl. No.: 09/891,953

(22) Filed: Jun. 26, 2001

Related U.S. Application Data
(60) Provisional application No. 60/214,151, filed on Jun. 26, 2000.
(60) Provisional application No. 60/254,749, filed on Dec. 11, 2000.

(51) Int. Cl. G10L 11/00; H04M 1/64

(52) U.S. Cl. 704/270; 379/88.17

(57) ABSTRACT

A system and method to allow communications systems users, such as internet users, to create and retrieve audio files from a centrally stored database, without requiring specific installation of software or hardware. In one embodiment, the system and method are implemented entirely in JAVA to allow compatibility across all operating systems and to preclude specific installation requirements. The audio data may be posted to an internet browser using HTTP conventions to eliminate firewall and other filtering issues. Audio posting and listening capabilities may also be provided to subscriber websites without imposing software, hardware, or bandwidth constraints. Specified URLs on subscriber websites may call a generic applet that, together with subscriber identification information, allows for the display of customer specific graphics on the subscriber website. The centrally located database may be categorized by subscriber for privacy issues.

### CLAIM OF PRIORITY

This application claims priority to U.S. Ser. No. 60/214,151, entitled “Networked Audio Posting Method and Apparatus,” filed on Jun. 26, 2000, naming Jeffrey M. Valentine, Michael Bernardo, and Benjamin Krysiak as inventors, the contents of which are herein incorporated by reference in their entirety, and this application also claims priority to U.S. Ser. No. 60/254,749 entitled “Networked Audio Posting Method and Apparatus,” filed Dec. 11, 2000 and naming Jeffrey M. Valentine, Michael Bernardo, and Benjamin Krystak as inventors, the contents of which are herein incorporated by reference in their entirety.

### BACKGROUND

(1) Field

The disclosed methods and systems relate generally to audio data on a communications network, and more particularly to distributing audio data on a communications network such as the internet.

(2) Description of Related Art

The internet is arguably the most well-known communications network, with a percentage of personal computers purchased for the sole purpose of internet communications. A popular feature of the internet is the World Wide Web that allows network users access to posted electronic information at an ever-increasing number of “websites” located throughout the network. Accordingly, other devices such as cellular phones and personal digital assistants (PDAs) are being enhanced to provide internet accessibility.

Media data including audio and graphics information, can be among the more popular data accessed through the internet. Additionally, streaming audio and/or video data can be accessed in near real-time, allowing users to listen to radio broadcasts, for example. There are many different applications that may be installed on various user's personal computers to facilitate the download and subsequent listening to or viewing of audio or video data, respectively.

Similarly, for an internet user to create audio or video data, specialized software applications and accessory equipment can be required to be installed on the user's personal computer or other network accessible device. Such applications can be expensive, can require frequent updates, and can consume large amounts of memory. Additionally, the applications can be operating-system dependent, and therefore a user typically cannot transport the application to another computer with a different operating-system. Similarly, data generated on one particular operating system may not be viewed on or accessed by a personal computer or other device using a different operating system.

### SUMMARY

The systems and methods allow audio data to be distributed with text documents, including HTML documents, over a network such as the internet. The audio data can be an audio file that can be located on a central server that can also be accessed by the network. The audio data can be associated with at least one identifier that can include, for example, a Personal Identification Number (PIN) or a customer ID number, although such examples are provided for illustration and not limitation. In some embodiments, a second identifier can be generated and associated with the audio data. The second identifier can thereafter be provided for incorporation in the text document. For example, the second identifier can be associated with a pointer or other reference that is included in the text document. Additionally or optionally, the second identifier can be provided in an email or HTTP post that can allow the audio data to be referenced and/or approved before the second identifier is included in the text document. In some embodiments, the second identifier can be the same as the first identifier.

Other objects and advantages of the methods and systems will become obvious hereinafter in the specification and drawings.

### BRIEF DESCRIPTION OF THE DRAWINGS

FIG. 1 is an architectural block diagram of a system implementing one embodiment of the invention;

FIG. 2 is a block diagram of a first embodiment according to FIG. 1;

FIG. 3 is a block diagram of a second embodiment according to FIG. 1;

FIG. 4 is a representative diagram of a database for systems according to FIGS. 1 through 3;

FIG. 5 is a block diagram of a third embodiment according to FIG. 1; and, FIG. 6 is a block diagram of a fourth embodiment according to FIG. 1.

### DESCRIPTION

To provide an overall understanding, certain illustrative embodiments will now be described; however, it will be understood by one of ordinary skill in the art that the systems and methods described herein can be adapted and modified to provide systems and methods for other suitable applications and that other additions and modifications can be made without departing from the scope of the systems and methods described herein.

The systems and methods allow communications systems users, such as internet users, to create audio files, and post such audio files on a common or centrally located server for retrieval (e.g., listening). In some embodiments, the audio files can be protected to allow retrieval and/or editing by specified or identified users, using, for example, a PIN. The audio creation, posting, and retrieval can allow network users to listen to streaming audio while viewing a website, web page, email, or other text document, without requiring local software or hardware installation. Warning boxes that can be caused by required installations, and buffering delays, can be avoided with the systems and methods.

In one embodiment, the audio stream can be served by HTTP on port 80 to eliminate firewall or other filtering exclusions.

In one embodiment, the methods and systems can be implemented using a platform independent technology such as Java. In such an embodiment, the methods and systems may not require installation, but rather, can utilize the processes of the installation-free native code Java applet. The audio data can be posted using standard HTTP conventions to allow anyone with a computer microphone and computer audio listening device to create and listen to audio files.

The methods and systems can also convert an audio stream from one format to another format, for example, from the well-known “GSM.wav” format, to the “mu-law.au” format.

In one embodiment, internet users in a threaded discussion group can exchange entertainment and information in an audio form. For example, one user can post an audio message to the group, wherein another user can thereafter listen to the audio message and reply to it by creating another audio message. The original posting can constitute a new thread such that other users can increase the size of the thread by replying (with their own voice) to either the original or second user. Other users can additionally select to start a new thread.

The methods and systems can be provided as a tool that can be understood as a service to a subscriber website. The service can provide audio posting capability to the website as a private-labeled feature, without imposing significant software, hardware, or bandwidth constraints on the subscriber or the subscriber's resources. In one embodiment, a specified Universal Resource Location (URL) can be added to the subscriber web site, wherein the URL can activate an applet that is customized or private-labeled for the subscriber, and by the subscriber. The applet can present a user of the subscriber website with audio controls, prompting the user to, for example, record, stop, preview, pause, and save a spoken audio clip or audio data that the user can record by speaking into a microphone. The user-generated audio data can be accepted as an audio file for transmission to a centrally located server or other computer. The central server can issue a HTTP post to a specified CGI/servlet acceptor that receives information on the storage location of the file, and stores it in a subscriber database. The subscriber website can include another URL that can activate an applet that is private-labeled for that subscriber, to present a subscriber website user with audio controls to pause, stop, and view the progress of an audio playback in response to an audio file that can be requested from the central server. The central server can return the audio file to the subscriber computer, and the user can listen to the file using an audio device.

The methods and systems can dynamically generate the central server location of an audio file that is created and stored to the central computer, as described herein, and later retrieved.

The subscriber can provide full audio message board functionality as a complete product, without requiring website software, hardware, or other infrastructure alterations.

As indicated herein, the methods and systems can provide private-labeled applets to website subscribers. In one embodiment, a generic applet, when called by a subscriber's web page, can activate the applet server and communicate the subscriber identification. The server can return assorted graphics to the generic applet for display by the generic applet, thereby presenting to the subscriber a customized, subscriber-specific applet.

The methods and systems can hence allow audio data to be associated with a text document. In some embodiments, the text document can be a HTML document, including a web page, although such an example is provided merely for illustration and not limitation. Those with ordinary skill in the art will recognize that web pages include merely one form of HTML documents, and other HTML and non-HTML documents can be utilized while remaining within the scope of the disclosed methods and systems.

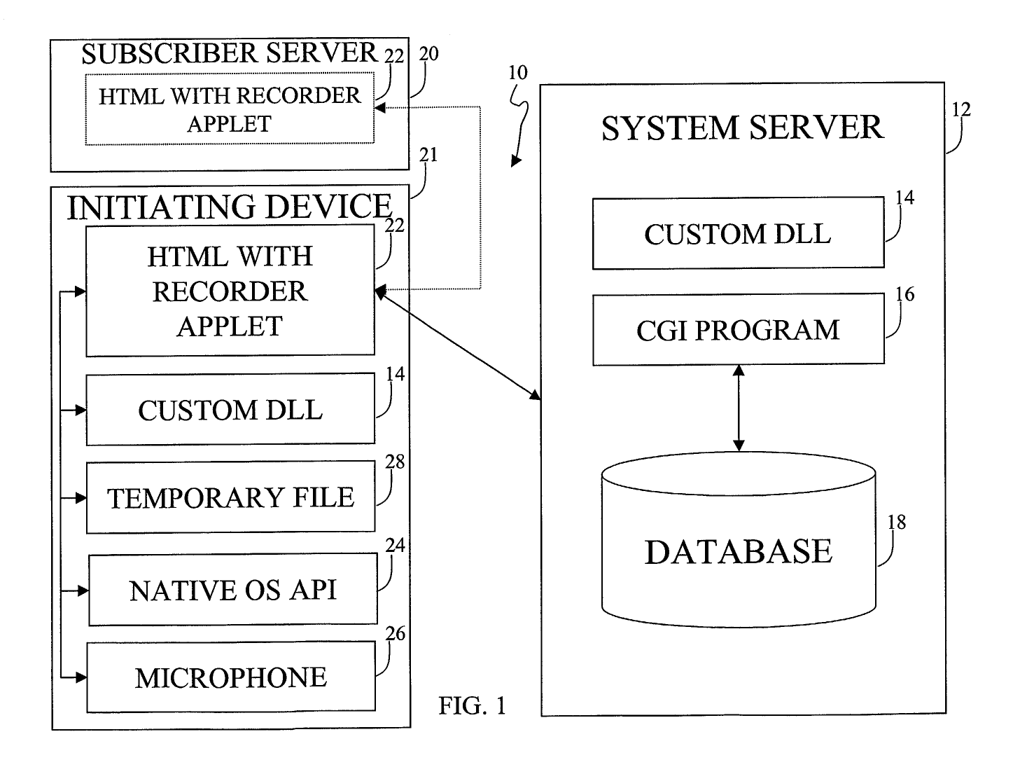

Referring now to FIG. 1, there is a block diagram of a system 10 that includes one embodiment of the methods and systems disclosed herein for posting audio data for access by a network or other remote device, including for example, a telephone. Accordingly, although the systems and methods have wide applicability, for the purposes of illustrative discussion, it can be understood that the illustrated systems and methods can be described relative to systems and methods that can be implemented across a computer network such as the internet, although such an example is provided for illustration and not limitation. According to an internet embodiment, an internet user can access the internet using what can be referred to herein as an initiating device 21. The initiating device 21 can include a digital computer system that can utilize a wired or wireless communications link to connect to a communications network such as the internet. A user of the initiating device 21 can utilize different peripheral devices that can be integrated with or otherwise configured for compatible use with the initiating device 21. For example, the initiating device 21 can include a keyboard, keypad, stylus, digital camera, microphone, etc., that can communicate data to the initiating device 21 using wired or wireless communications systems and/or protocols, etc. The initiating device 21 can be a microprocessor-based system including a computer workstation, such as a PC workstation or a SUN workstation, handheld, palmtop, laptop, personal digital assistant (PDA), cellular phone, etc., that includes a program for organizing and controlling the initiating device 21 to operate as described herein. Additionally and optionally, the initiating device 21 can be equipped with a sound and video card for processing multimedia data. The initiating device 21 can operate as a stand-alone system or as part of a networked computer system. Alternatively, the initiating device 21 can be dedicated devices, such as embedded systems, that can be incorporated into existing hardware devices, such as telephone systems, PBX systems, sound cards, etc. Accordingly, it will be understood by one of ordinary skill in the art that the initiating device 21 described herein has wide applicability and can be incorporated in many systems, and realized in many forms.

Those with ordinary skill in the art will recognize that the initiating device 21 can be connected to a network such as the internet and can be equipped with what is well-known as an internet “browser” such as the commercially available Netscape Navigator, Internet Explorer, etc., browsers. Depending upon the initiating device 21 and its configuration, the browser can differ, and hence references herein to a browser can include references to a user interface to the internet or other network, wherein the methods and systems herein are not limited to the browser or other network interface. Furthermore, the initiating device 21 can access the internet using wired or wireless communications links and/or protocols.

As is well-known in the art for internet communications, the initiating device 21 can communicate with other devices on the internet. These other devices can be similar to the initiating device 21, however common terminology includes “servers” that can include or “host” web pages. The initiating device 21 can contact a server 12, 20 and cause the server 12, 20 to provide information for display on the initiating device 21. Such information can include, but is not limited to, a web page associated with the server 12, 20. Accordingly, a server 12, 20 can be also be a microprocessor-based system including a computer workstation, such as a PC workstation or a SUN workstation, handheld, palmtop, laptop, personal digital assistant (PDA), cellular phone, etc., that includes a program for organizing and controlling the server 12, 20 to operate as described herein. Additionally and optionally, the server 12, 20 can be equipped with a sound and video card for processing multimedia data. The server 12, 20 can operate as a stand-alone system or as part of a networked computer system. Alternatively, the server 12, 20 can be dedicated devices, such as embedded systems, that can be incorporated into existing hardware devices, such as telephone systems, PBX systems, sound cards, etc. In some embodiments, servers 12, 20 can be clustered together to handle more traffic, and can include separate servers for different purposes such as a database server, an application server, and a Web presentation server. The server 12, 20 can also include one or more mass storage devices such as a disk farm or a redundant array of independent disk (“RAID”) system for additional storage and data integrity. Read-only devices, such as compact disk drives and digital versatile disk drives, can also be connected to the server 12, 20. As used herein, the term “server” is intended to refer to any of the above-described servers. In an embodiment, the initiating device 21 and the server 12, 20 can be similar systems.

Alternately, the term “web page” can be understood to include any document that is associated with a Universal Resource Locator (URL) on the internet or World Wide Web. Those with ordinary skill in the art will recognize that there can be varying formats for web pages, and these formats can include HTML code, perl scripts, java scripts, applets, etc., that can be integrated into the documents. Accordingly, an initiating device 21 can contact a server 20 and the server 20 can cause a web page to be transferred to the initiating device 21 and appear on the display of the initiating device 21, via the browser.

Referring back to FIG. 1, there is a system server 12 that can be understood to include one or more servers. As FIG. 1 illustrates, the system server 12 includes at least one custom dll (dynamic link library) 14 that can be described further herein, at least one CGI (common gateway interface) program 16 that can also be described further herein, and at least one database 18 that can include, for example, audio files. The illustrated database 18, and the databases disclosed herein, can be accessed locally or through a network such as the internet using wired or wireless communications devices and protocols. The database 18 can be understood to include a memory having one or more physical or logical partitions and/or segments, and can optionally and additionally utilize one or more of well-known database packages including MySQL, SQL, Oracle, Informix, Sybase, the Freedom Engine, Access, ODBC, DB2, etc., with such examples provided for illustration and not limitation. In an embodiment, the database 18 can reside in a memory of the system server 12.

The illustrated database 18 can also associate audio files with data representing identifiers, for example, a personal identification number (PIN), a media_ID identifier, a customer identification identifier, and/or a duration of the audio file. Although the illustrated systems utilize integers to represent the aforementioned quantities, those with ordinary skill in the art will recognize that the methods and systems are not limited to the identifier format or composition.

FIG. 1 also includes a subscriber server 20 that can represent a subscriber to the services or methods and systems provided herein and facilitated by the system server 12. A subscriber server 20 can be an internet entity having a web page at an identified URL, and a user at an initiating device 21 can cause the subscriber server's web page to be transferred and otherwise displayed on the initiating device 21. Accordingly, those with ordinary skill in the art will recognize that the subscriber server web page can be encoded using HTML, and the HTML coding can include a recorder applet 22. When the web page and recorder applet are transferred to the initiating device 21, the recorder applet can survey the initiating device 21 to determine if the custom dll 14 resides on the initiating device 21. If the custom dll 14 is not present on the initiating device 21, the recorder applet 22 can cause the custom dll 14 to be retrieved from the system server 12, via the communications network or other communications system. The custom dll 14 can thereafter be stored within the local memory of the initiating device 21. In an embodiment, the custom dll 14 includes versioning flags, hence the recorder applet 22 can automatically update the latest version of the custom dll 14.

For the FIG. 1 system, the recorder applet 22 can provide a Java GUI (graphical user interface) to the initiating device user 21. The GUI can include buttons to record, play, stop, pause, erase, and preview audio data, etc., and transmit (“save”) an audio file to the system server 12. The illustrated recorder applet 22 utilizes the custom dll 14 as a connection between a native operating system sound API (Application Programmer Interface) 24 and a microphone 26. The microphone 26 can be internal or external to the initiating device 21. The illustrated applet 22 can utilize, for example, Java Native Interface (JNI) to communicate with the native operating system dlls to open a sound card associated with the initiating device 21, capture sound from the microphone, and store the audio stream in a temporary file 28 in local memory of the initiating device 21. Accordingly, a user at the initiating device 21 can manipulate (preview, pause, stop, play, etc.) the audio data in the temporary file 28, and/or transmit the audio file to the system server 12.

Upon the user indicating a decision to save or transmit the audio file, the recorder applet 22 can utilize a HTTP Post operation to submit the file to a CGI program 16 on the system server 12. The recorder applet 22 can transmit the audio binary data, and other descriptive information including, for example, the duration of the audio file and at least one identifier that can identify the subscriber. In some embodiments, an identity for the user 21 can be generated. The CGI program 16 can cause the received data to be parsed, can generate a media_ID for the audio file, and can include the received and generated data in the database 18.

In an embodiment according to FIG. 1, the applet 22 can be a generic applet that can be customized using parameters designated by the subscriber server. Accordingly, the GUI and other applet functionality can be specified and/or selected by a subscriber.

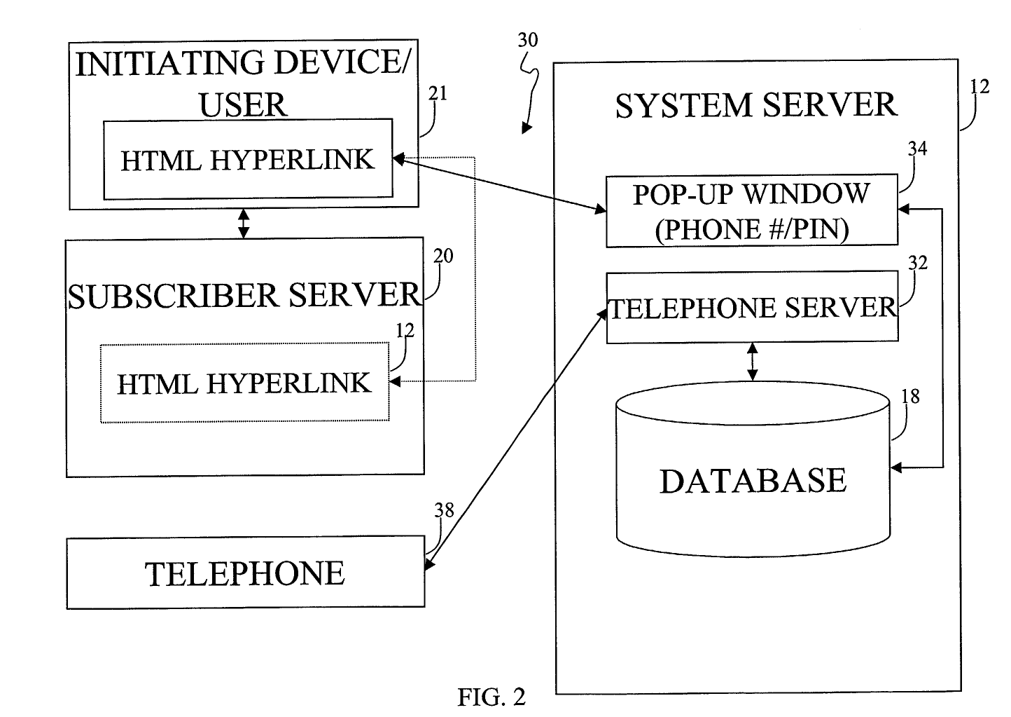

Referring now to FIG. 2, there is an embodiment 30 that can be utilized optionally and additionally to an embodiment according to FIG. 1. In an embodiment according to FIG. 2, a telephone 38 can be utilized to post information to the system server 12. The FIG. 2 system server 12 optionally and additionally includes a telephone server 32 and at least one database 18. The database 18 of FIGS. 1 and 2 can be the same or different databases. The FIG. 2 system server 12 also includes a program, for example, a Java program, that provides a pop-up window 34. The program 34 can be invoked through a HTML hyperlink 36 that can be included on a subscriber server's web page that is thereafter downloaded to an initiating device 21 by a user.

When the illustrated pop-up window 34 is activated by the initiating device user 21 through the hyperlink 36 associated with subscriber server's web page, the pop-up window 34 can detect the subscriber server's 20 identity, and can provide the initiating device user 21 with a telephone number to dial, and a Personal Identification Number (PIN) that can be associated with the subscriber server. In the FIG. 2 system, the PIN and telephone number can be provided with a graphic. The user 21 can thereafter utilize the telephone 38 and the provided telephone number to connect to the telephone server 32 that can, according to the PIN (and hence the subscriber server identity), generate a subscriber-customized set of telephone prompts to allow the user 21 to record audio data. For example, the user can utilize telephone keypad buttons and/or voice commands to record, play, preview, stop, pause, erase, and save or transmit the audio data. Accordingly, the audio prompts, prompt order, logic flow between prompts, and actions resulting from prompts, can be customized. Upon termination of the telephone call and recognition of saved data, the telephone server 32 can cause the audio file to be stored in the database 18 with other associated data including, for example, the PIN, a generated media_ID, and duration data based on the created audio file.

Those with ordinary skill in the art will recognize that the FIG. 2 pop-up window 34 can be implemented using a high-level language such as Java, C, C++, etc., or assembly language, although such examples are provided for illustration and not limitation.

In an embodiment according to FIG. 2, users 21 can be associated with a subscriber server 20 and can accordingly be provided pre-defined PINs that can allow the users 21 to provide audio data directly via telephone without accessing a subscriber web page to obtain a telephone number and/or PIN.

Those with ordinary skill in the art will recognize that the methods and systems of FIGS. 1 and 2 can be combined to a single system that allows posting of audio data via microphone and/or telephone. In an embodiment with such capability, an applet can present an option graphic to the user 21 that allows the user to select the microphone or telephone posting methods and systems.

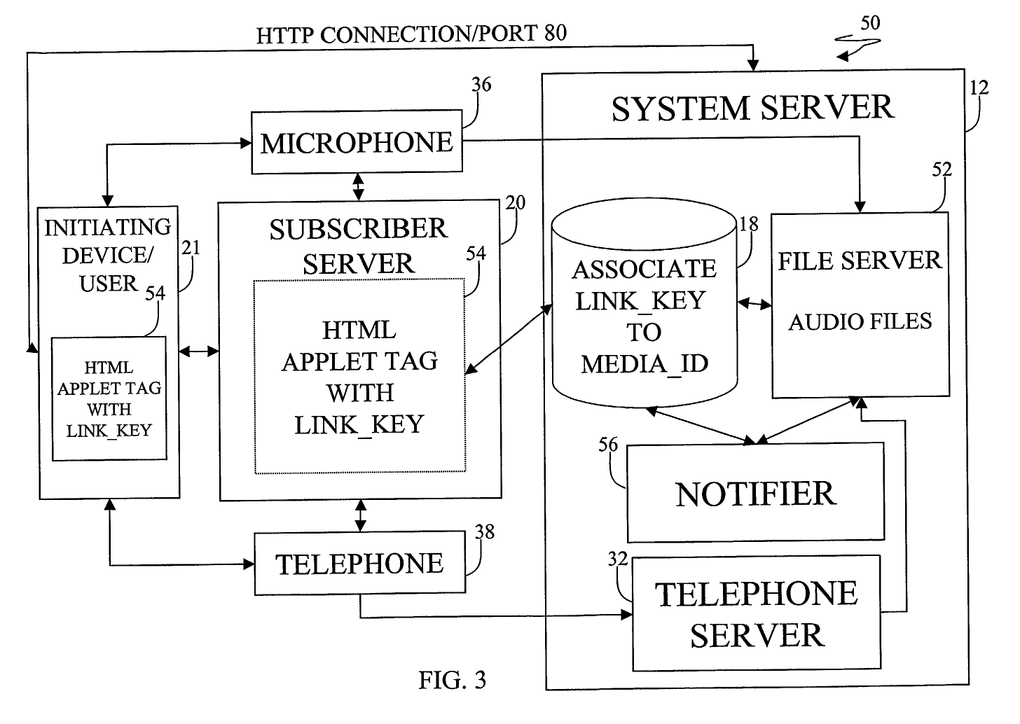

Referring now to FIG. 3, there is a representative block diagram 50 that employs methods and systems according to FIGS. 1 and 2. As FIG. 3 indicates, the system server 12 can include a file server 52 that can include audio files. In the FIG. 3 system, the audio files can be stored in “.wav” format, although such an example is provided for illustration and not limitation. The file server 52 can be in communication with a database 18 that can associate Link_keys to media_IDs. The FIG. 3 database 18 can be the same or a different database as indicated and otherwise depicted in FIGS. 1 and 2. For the FIG. 3 systems and methods, the media_IDs associate to an audio file, and for the illustrated systems and methods, an audio file has a unique media_ID. Alternately, a media_ID can be associated with more than one Link_key, although in some embodiments, a unique relationship between media_ID and Link_Key can be provided. Furthermore, a Link_Key can be associated with a subscriber server 20. As FIG. 3 illustrates, the subscriber server 20 can have a web page that includes an HTML applet tag 54 that includes a Link_key associated with the subscriber and/or subscriber server 20. The HTML applet tag 54 references an applet on the system server 12. The media_ID can also be generated using an applet on the system server 12. In some embodiments, the media_ID can be the same as a PIN or customer ID, and in such embodiments, a separate media_ID may not be generated.

With continued reference to FIG. 3, when a user of an initiating device 21 transfers the subscriber server's 20 web page, the applet is transferred to the initiating device 21 and communicatively connects the initiating device 21 to the system server 20. Accordingly, for the illustrated system, when the applet is activated or receives a request to play an audio file, the applet makes a standard HTTP connection over port 80, to the system server 12. In an embodiment, the applet can utilize a first “get” to retrieve information about the audio file that includes the duration and the physical location. In a second “get”, the applet can retrieve the audio file utilizing a data buffering technique to determine a buffer size based on the internet or other network latency issues, and the user's 21 connection speed.

In one embodiment, the audio file can be offered using an 8 KHz GSM format, where the applet can decode the audio stream in real time to a 8 KHz mu-law format that can be compatible with Java's audio API. Additionally and optionally, a 8 KHz mu-law format can be used that can stream at 8 Kbps using an applet footprint on the initiating device 21. The applet for retrieving audio data can therefore provide an interface between the audio file and a destination for the audio data, where the destination can include a sound card or other interface to allow the audio data to be heard or otherwise presented to a user of the initiation device 21.

The applet for retrieving audio data and/or files can also be customized according to parameters established on the subscriber server 20 and/or by an entity having administrative responsibilities for the subscriber server's web page. Accordingly, the applet can be configured to provide a GUI or not provide a GUI. If a GUI is provided, the GUI can be customized with play, pause, stop, etc., buttons, a progress bar, various background and surround images, etc., and such customization parameters are provided for illustration and not limitation.

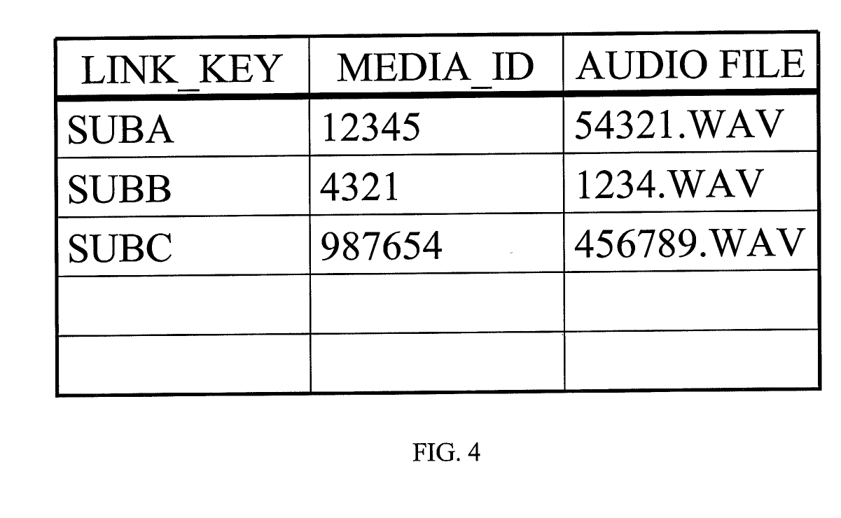

For example, referring to FIG. 4, a relationship between Link_keys, media_IDs, and audio files can be shown according to the methods and systems described herein. It can be understood that other data, such as duration of the audio file, can also be associated with the information displayed in FIG. 4, and hence FIG. 4 is merely representative of some information that can be associated. Accordingly, when the initiating device 21 of FIG. 3 activates the applet and the applet establishes a HTTP connection over port 80, the Link_key provided by the applet can identify a media_ID, which can thereafter identify an audio file. Furthermore, using a method or system according to FIGS. 1 and/or 2, an entity associated with the subscriber server 20, either using the telephone 38 and/or the microphone 26, and either with or without the use of an initiating device 21, can create a new audio file using methods and systems described herein. As indicated herein, a new audio file can be accompanied by an associated media_ID. By specifying a PIN and/or subscriber 20 with the creation of the new audio file (either by telephone or microphone), the system server 12 can associate the new audio file with a Link_Key (associated with a subscriber server 20) using a notifier module 56, and cause the database 18 to be updated with the new media_ID and hence, the associated new audio file. Using these methods and systems, a subscriber can modify the audio content associated with the subscriber server's web page, without modifying the web page.

In an embodiment, a subscriber can be provided with a telephone number and associated PIN to generate new audio files. Additionally and optionally, a subscriber can be provided with a URL that can provide a microphone applet that can prompt the user for a PIN, and thereafter associate a new audio file with a particular Link_ID.

In some embodiments according to FIG. 4, a history of Link_ID associations with media_IDs and audio files can be preserved to allow a subscriber to re-access or review audio files previously associated with the subscriber's web page. In some embodiments, a subscriber can have multiple PINs for multiple web pages, or multiple PINs for a single web page.

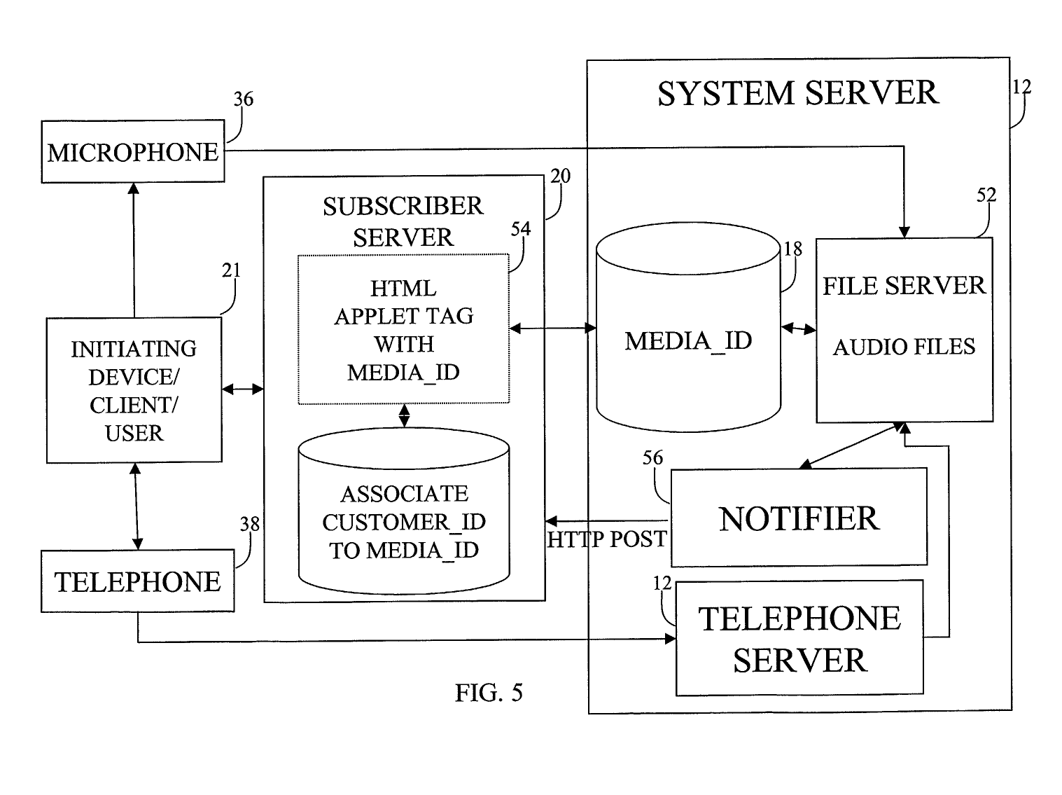

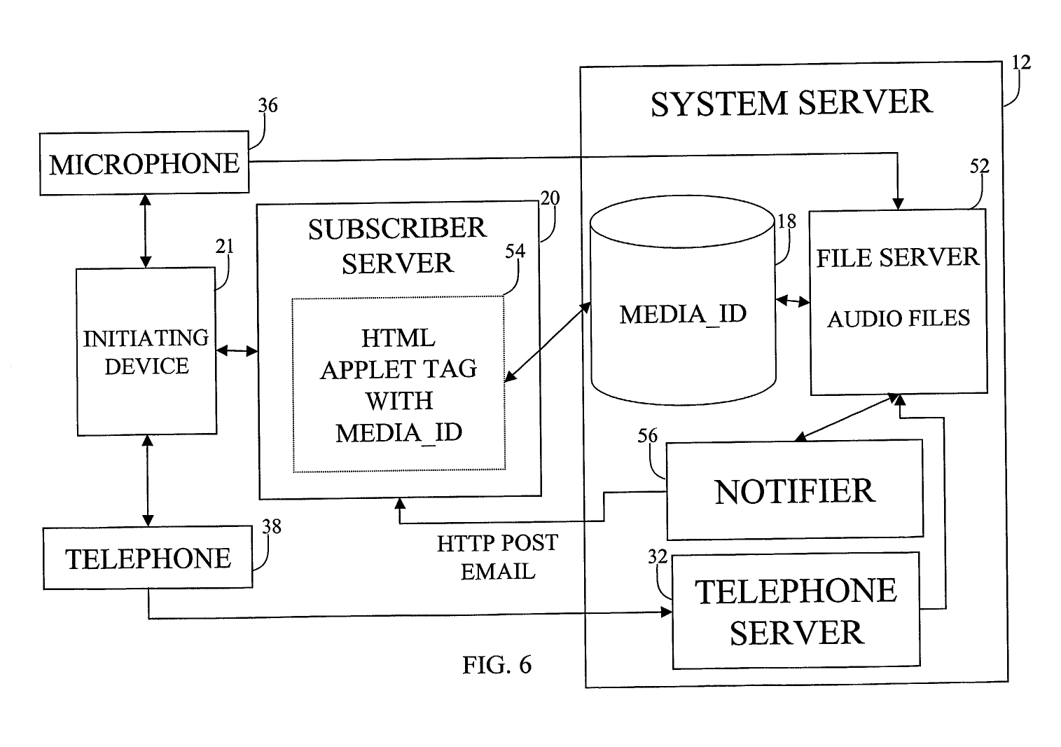

Referring now to FIG. 5, there is an embodiment employing the methods and systems herein that can allow various individuals to post audio on a subscriber's web page. Consider, for example, a web page that can be utilized for auctions, or additionally and optionally, for presenting items for sale, etc. In some embodiments of these web pages, a user can register with the subscriber's web page by listing an item for sale. An applet or script can provide the user with a form for detailing particulars related to the item. In one embodiment, the user can be provided with an option for generating an audio file for association with the item. In one embodiment of such a system, the user can be presented with a “selection applet” that can be embedded within the subscriber's web page, and when selected, provides the user with an option of adding audio capability via a microphone or telephone. Depending upon the selection of microphone or telephone, the system server 12 can be contacted to generate a PIN, or PIN and telephone number combination, respectively. The PIN and/or a customer ID number, or other identification data, can thereafter be utilized to associate the yet-to-be-created audio file with the subscriber server 20 and the item or product that the user is advertising. Using the methods and systems described herein, the user can then view a customized applet (microphone) or access customized telephone prompts (telephone) to record, review, etc. an audio file as provided previously herein. Once the audio file and PIN are received and associated, a media_ID can be generated and associated with the audio file and stored in the database 18. The notifier module 56 can thereafter generate a HTTP post to the subscriber server 20 to provide the media_ID and the associated customer information to the subscriber server 20. The subscriber server 20 can thereafter create a HTML applet tag that includes the media_ID, such that when the subscriber web page is downloaded by a user and the user selects an option to listen to the audio data, a connection to the system server 12 and the audio file can be made using the media_ID. In some embodiments, the subscriber server 12 can therefore maintain a database or other record of media_IDs and customer IDs and/or product identification, or other type of association.

For the systems and methods described according to FIG. 5, the HTTP post from the notifier module 56 can be received by a CGI program on the subscriber server 20. Accordingly, clients (e.g., those posting items and/or audio on the subscriber server 20) of the subscriber server 20 can modify associated audio automatically and independently, without requiring the subscriber to change the web page. In other embodiments, a subscriber's CGI program that receives the HTTP post, may not automatically update the file, and may provide a mechanism to allow approval of audio before posting.

The systems and methods disclosed herein can thus be widely utilized. For example, the systems and methods according to FIG. 3 can be deemed “static” systems and methods that can include a non-changing PIN that can allow a web page to be automatically updated with audio without requiring a subscriber to change or otherwise alter a web site. Other embodiments according to FIG. 5 can be termed “dynamic” systems and methods that can provide a new PIN to an entity to allow a conditional updating of audio data based on, for example, proper identification (customer ID, PIN, or other identifying information) and/or approval by the subscriber server. It can be understood in such systems that PINs can be dynamically generated.

In another embodiment that can be referred to herein as “hybrid” systems and methods, non-changing PINs can be provided to certain entities (e.g., individual, group, or other capable of recording audio); however, rather than automatically causing an update of the information per the static systems and methods, the hybrid systems can allow approval of the audio postings per the dynamic systems and methods. Accordingly, a system and method according to FIG. 6 can be understood to represent hybrid methods and systems. As indicated in FIG. 6, a subscriber server 20 can be equipped, as in the dynamic systems and methods, with a web page that includes a HTML applet tag having a media_ID. The web page can accordingly be downloaded to an initiating device 21. Accordingly, a user with a PIN can either activate a URL to record audio data using a microphone applet, or record audio data using a telephone (either after accessing the subscriber web site, or independent of the web site). Once the recorded data is posted to the file server 52 of the system server 12 and a new media_ID is generated and stored in the media ID database 18, the notifier module 56 can generate an email to the subscriber 20 to indicate that a new audio file is available, specifying the new media_ID. Accordingly, a subscriber, using either a specified URL and PIN, or a designated telephone number and PIN, can access the audio data via the new media_ID, to approve the audio. Upon approval, the subscriber 20 can alter the HTML applet tag 54 to include the new media_ID.

As indicated herein, for the systems and methods, audio files can be accessed for listening via a URL or an applet tag that can be embedded in a web page. Additionally, audio files can be accessed independent of a web page, via a telephone, with the appropriate PIN and/or customer ID, and media_ID.

Those with ordinary skill in the art will recognize that the subscriber server 20 of the illustrated embodiments can be replaced with or otherwise be accompanied by an email server. Accordingly, in one such embodiment, a user can access a web page, and be provided with an option to post audio data via a microphone or telephone, as provided herein. The user can also designate one or more email addresses, a written message, a subject, cc'ed email addresses, etc. Upon posting of the audio message to the system server 12, a media_ID can be generated and the notifier module 56 can post the media_ID and email information to an email server that can generate an email. The email can be, for example, a HTML document that can include HTML applet tags that can reference applets on the system server 12. In one embodiment, the HTML email document can include a reference to the audio player applet with standard (customized) features selected.

What has thus been described is a system and method to allow communications systems users, such as internet users, to create and retrieve audio files from a centrally stored database, without requiring specific installation of software or hardware. In one embodiment, the systems and methods are implemented entirely in JAVA to allow compatibility across all operating systems and to preclude specific installation requirements. The audio data may be posted to an internet browser using HTTP conventions to eliminate firewall and other filtering issues. Audio posting and listening capabilities can also be provided to subscriber websites without imposing software, hardware, or bandwidth constraints. Specified URLs on subscriber websites may call a generic applet that, together with subscriber identification information, allows for the display of customer specific graphics on the subscriber website. The centrally located database may be categorized by subscriber for privacy issues.

The methods and systems described herein are not limited to a particular hardware or software configuration, and may find applicability in many computing or processing environments. The methods and systems can be implemented in hardware or software, or a combination of hardware and software. The methods and systems can be implemented in one or more computer programs executing on one or more programmable computers that include a processor, a storage medium readable by the processor (including volatile and non-volatile memory and/or storage elements), one or more input devices, and one or more output devices.

The computer program(s) is preferably implemented using one or more high level procedural or object-oriented programming languages to communicate with a computer system; however, the program(s) can be implemented in assembly or machine language, if desired. The language can be compiled or interpreted.

The computer program(s) can be preferably stored on a storage medium or device (e.g., CD-ROM, hard disk, or magnetic disk) readable by a general or special purpose programmable computer for configuring and operating the computer when the storage medium or device is read by the computer to perform the procedures described herein. The system can also be considered to be implemented as a computer-readable storage medium, configured with a computer program, where the storage medium so configured causes a computer to operate in a specific and predefined manner.

Although the methods and systems have been described relative to a specific embodiment thereof, they are not so limited. Obviously many modifications and variations may become apparent in light of the above teachings. For example, although the illustrated embodiments included block diagrams, the blocks and associated features can be combined in different ways and the illustrated presentation of features is provided merely to facilitate understanding and not to provide limitation. Additionally, many devices exist for accessing the internet without the use of a computer, for example, using a modem that provides information to a television screen for display. The invention herein is not limited to the Network User access method, and any acceptable configuration or method for accessing the internet or communications network is acceptable. Although the methods and systems disclosed were applied to a web page, the methods and systems can be used to generate another type of HTML document, such as an email that can be provided to an email server. It can thus be understood that an email server can replace or otherwise accompany the subscriber server in the illustrated embodiments. Additionally, although HTML documents were used in the example systems and methods, other document formats, including XML, SGML, GML, or other markup languages, can be used. Although the methods and systems utilized Java for components, other languages can be used. Similarly, although applets and applet tags were illustrated, other methods of providing pointers can be used. Although the audio data can be played and otherwise presented to a speaker or other listening device as an output device, the audio data can also be converted for presentation, from audio, to text, for example, using well-known speech recognition products. In such an embodiment, the output device for the audio can be a speech recognition module.

Many additional changes in the details, materials, and arrangement of parts, herein described and illustrated, can be made by those skilled in the art. Accordingly, it will be understood that the following claims are not to be limited to the embodiments disclosed herein, can include practices otherwise than specifically described, and are to be interpreted as broadly as allowed under the law.

What is claimed is:

1. A method for distributing audio data with at least one text document over a network, the audio data located on at least one server, the method comprising,
receiving the audio data and a first identifier associated with the audio data source,
generating a second identifier for association with the audio data, and,
providing the second identifier for incorporation with the at least one text document.

2. A method according to claim 1, wherein receiving the audio data further includes receiving the audio data from at least one of a network, a computer network, and a telephone network.

3. A method according to claim 1, wherein receiving a first identifier includes receiving at least one of a personal identification code (PIN), a customer identification, a product identification, and a network address.

4. A method according to claim 1, wherein generating a second identifier further includes generating a media_ID.

5. A method according to claim 1, wherein providing the second identifier for incorporation with the at least one text document further includes changing a database element accessed by the at least one text document.

6. A method according to claim 1, wherein providing the second identifier for incorporation with the at least one text document further includes providing an email including the second identifier.

7. A method according to claim 1, wherein providing the second identifier for incorporation with the at least one text document further includes generating a HTTP post to a server associated with the at least one text document.

8. A method according to claim 1, further including providing an interface to receive audio data by at least one of a network microphone and a telephone.

9. A method according to claim 1, further including providing a dynamically generated PIN to a source of the audio data.

10. A method according to claim 1, further including providing a Java applet to be referenced by the at least one text document, the Java applet including instructions based on Java Native Interface.

11. A method according to claim 1, further including providing a Java applet to be referenced by the at least one text document, the Java applet including instructions for receiving the audio data using a microphone.

12. A method according to claim 1, further including providing a Java applet to be referenced by the at least one text document, the Java applet including instructions for controlling the audio data.

13. A method according to claim 1, further including providing a Java applet to be referenced by the at least one text document, the Java applet to include instructions to transfer the audio data to the at least one server.

14. A method according to claim 1, further including providing a Java applet to be referenced by the at least one text document, the Java applet to include instructions to at least one of record, play, pause, save, and stop the audio data.

15. A method according to claim 1, further including providing a Java applet to be referenced by the at least one text document, the at least one text document further including parameters to customize the Java applet.

16. A method according to claim 1, wherein receiving a first identifier includes identifying the first identifier as a static PIN or a dynamic PIN.

17. A method according to claim 1, wherein generating a second identifier for association with the audio data includes generating a second identifier based on the first identifier.

18. A method according to claim 1, wherein generating a second identifier for association with the audio data includes recognizing the second identifier as the first identifier.

19. A method according to claim 1, wherein distributing audio data with at least one text document includes distributing audio data with at least one HTML document.

20. A method according to claim 1, further including providing a HTML applet tag in the at least one text document.

21. A method according to claim 1, further including receiving a duration of the audio data.

22. A method according to claim 1, further including,
receiving a request to post audio data, and,
dynamically generating a PIN based on the request.

23. A method according to claim 1, further including,
receiving a request to post audio data, and,
providing at least one of a telephone number and a dynamically generated PIN based on the request.

24. A system for associating at least one text document with audio data, the system comprising,
at least one server connected to a network to receive the audio data from the network,
a first identifier associated with the audio data and received with the audio data, and,
a second identifier associated with the audio data and at least one text document on the network.

25. A system according to claim 24, wherein the network further includes at least one of a computer network and a telephone network.

26. A system according to claim 24, wherein the second identifier is the same as the first identifier.

27. A system according to claim 24, wherein the first identifier includes at least one of a PIN, a customer identification, a product identification, and a network address.

28. A system according to claim 24, further including at least one database in communication with the at least one server, the at least one database to include the audio data.

29. A system according to claim 28, wherein the at least one database further includes at least one of the first identifier and the second identifier.

30. A system according to claim 24, wherein the at least one text document includes a HTML document.

31. A system according to claim 24, further including an email to distribute the second identifier based on the at least one text document.

32. A system according to claim 24, further including a HTTP post to distribute the second identifier based on the at least one text document.

33. A system according to claim 24, wherein the at least one server further includes a telephone server.

34. A system according to claim 24, wherein the server further includes at least one Java applet for reference by the at least one text document.

35. A system according to claim 24, wherein the at least one text document further includes at least one HTML tag.

36. A system according to claim 24, further including instructions to provide an interface to allow audio data reception via at least one of a telephone and a network microphone.

37. A system according to claim 24, wherein the first identifier includes at least one of a dynamically generated PIN and a static PIN.

38. A system according to claim 24, further including a Java applet including Java Native Interface instructions.

39. A system according to claim 24, further including a customizable applet for providing an audio player graphical user interface.

40. A system according to claim 24, wherein the second identifier includes a media_ID.

41. A system according to claim 24, further wherein the at least one server further receives a duration of the audio data.

42. A method for associating audio data with at least one text document, the method comprising,
receiving the audio data from a network at a server connected to the network,
receiving a first identifier at the server, the first identifier associated with the audio data,
providing a second identifier for association with the audio data, and,
providing the second identifier for association with the at least one text file.

43. A method according to claim 42, wherein receiving the first identifier includes receiving at least one of a PIN, a customer ID, a product ID, and a network address.

44. A method according to claim 42, wherein receiving the audio data from a network includes receiving the audio data via at least one of a computer network and a telephone network.

45. A method according to claim 42, wherein providing the second identifier for association with the at least one text file includes changing a database element accessed by the text document.

46. A method according to claim 42, wherein providing the second identifier for association with the at least one text file includes providing an email including the second identifier.

47. A method according to claim 42, wherein providing the second identifier for association with the at least one text file includes generating a HTTP post to a server associated with the text document.

48. A method according to claim 42, further including providing an interface to receive audio data by at least one of a microphone and a telephone.

49. A method according to claim 42, wherein receiving a first identifier includes receiving at least one of a dynamically generated PIN and a static PIN.

50. A method according to claim 42, further including,
receiving a request to post audio data, and,
dynamically generating a PIN based on the request.

51. A method according to claim 42, further including,
receiving a request to post audio data, and,
providing at least one of a telephone number and a dynamically generated PIN based on the request.

52. A system for associating at least one text document with audio data, the system comprising,
processor means connected to a network to receive the audio data from the network, to receive a first identifier associated with the audio data, and to provide a second identifier associated with the audio data and at least one text document on the network.

53. A system according to claim 52, wherein the processor means includes instructions for generating a HTML document.

54. A system according to claim 52, wherein the processor means includes instructions for providing a HTTP post to a server associated with the at least one text document.

55. A system according to claim 52, further including an email server in communication with the processor means.

56. A computer product according to claim 52, wherein the processor means includes instructions for providing a HTTP post to an email server.

57. A computer product for distributing audio data with at least one text document over a network, the audio data located on at least one server, the computer product comprising a processor with instructions for causing the processor to,
receive the audio data and a first identifier associated with the audio data source,
generate a second identifier for association with the audio data, and,
provide the second identifier for incorporation with the at least one text document.

58. A computer product according to claim 57, wherein instructions to receive the audio data further include instructions to receive the audio data from at least one of a network, a computer network, and a telephone network.

59. A computer product according to claim 57, wherein instructions to receive a first identifier include instructions to receive at least one of a personal identification code (PIN), a customer identification, a product identification, and a network address.

60. A computer product according to claim 57, wherein instructions to generate a second identifier further include instructions to generate a media ID.

61. A computer product according to claim 57, wherein instructions to provide the second identifier for incorporation with the at least one text document further include instructions to change a database element accessed by the at least one text document.

62. A computer product according to claim 57, wherein instructions to provide the second identifier for incorporation with the at least one text document further include instructions to provide an email including the second identifier.

63. A computer product according to claim 57, wherein instructions to provide the second identifier for incorporation with the at least one text document further include instructions to generate a HTTP post to a server associated with the at least one text document.

64. A computer product according to claim 57, further including instructions to provide an interface to receive audio data by at least one of a network microphone and a telephone.

65. A computer product according to claim 57, further including instructions to provide a dynamically generated PIN to a source of the audio data.

66. A computer product according to claim 57, further including instructions to provide a Java applet to be referenced by the at least one text document, the Java applet including instructions based on Java Native Interface.

67. A computer product according to claim 57, further including instructions to provide a Java applet to be referenced by the at least one text document, the Java applet including instructions for receiving the audio data using a microphone.

68. A computer product according to claim 57, further including instructions to provide a Java applet to be referenced by the at least one text document, the Java applet including instructions for controlling the audio data.

69. A computer product according to claim 57, further including instructions to provide a Java applet to be referenced by the at least one text document, the Java applet to include instructions to transfer the audio data to the at least one server.

70. A computer product according to claim 57, further including instructions to provide a Java applet to be referenced by the at least one text document, the Java applet to include instructions to at least one of record, play, pause, save, and stop the audio data.

71. A computer product according to claim 57, further including instructions to provide a Java applet to be referenced by the at least one text document, the at least one text document further including parameters to customize the Java applet.

72. A computer product according to claim 57, wherein instructions to receive a first identifier include instructions to identify the first identifier as a static PIN or a dynamic PIN.

73. A computer product according to claim 57, wherein instructions to generate a second identifier for association with the audio data include instructions to generate a second identifier based on the first identifier.

74. A computer product according to claim 57, wherein instructions to generate a second identifier for association with the audio data include instructions to recognize the second identifier as the first identifier.

75. A computer product according to claim 57, wherein instructions to distribute audio data with at least one text document include instructions to distribute audio data with at l east one HTML document.

76. A computer product according to claim 57, further including instructions to provide a HTML applet tag in the at least one text document.

77. A computer product according to claim 57, further including instructions to receive a duration of the audio data.

78. A computer product according to claim 57, further including instructions to,
receiving a request to post audio data, and,
dynamically generating a PIN based on the request.

79. A computer product according to claim 57, further including instructions to,
receiving a request to post audio data, and,
providing at least one of a telephone number and a dynamically generated PIN based on the request.
